(19) United States
(12) Patent Application Publication
(10) Pub. No.: US 2024/0037920 A1
(43) Pub. Date: Feb. 1, 2024

(54) CONTINUAL-LEARNING AND TRANSFER-LEARNING BASED ON-SITE ADAPTATION OF IMAGE CLASSIFICATION AND OBJECT LOCALIZATION MODULES

(71) Applicant: KONINKLIJKE PHILIPS N.V., EINDHOVEN (NL)

(72) Inventors: MATTHIAS LENGA, MAINZ (DE); AXEL SAALBACH, HAMBURG (DE); NICOLE SCHADEWALDT, NORDERSTEDT (DE); STEFFEN RENISCH, HAMBURG (DE); HEINRICH SCHULZ, HAMBURG (DE)

(21) Appl. No.: 18/267,800

(22) PCT Filed: Dec. 18, 2021
(86) PCT No.: PCT/EP2021/086676

§ 371 Date: Jun. 16, 2023

Related U.S. Application Data
(60) Provisional application No. 63/199,301, filed on Dec. 18, 2020.

(51) Int. Cl. G06V 10/774; G06V 10/764; G06V 10/776; G06V 10/22

(52) U.S. Cl. CPC G06V 10/774; G06V 10/764; G06V 10/776; G06V 10/235; G06V 2201/031

(57) ABSTRACT

A system and method for training a machine learning module to provide classification and localization information for an image study. The method includes receiving a current image study. The method includes applying the machine learning module to the current image study to generate a classification result including a prediction for one or more class labels for the current image study using User Interface 104 a classification module of the machine learning module. The method includes receiving, via a user interface, a user input indicating a spatial location corresponding to a predicted class label. The method includes training a localization module of the machine learning module using the user input indicating the spatial location corresponding to the predicted class label.

### BACKGROUND

Automated diagnostic systems utilizing, for example, machine learning, have been playing an increasingly important role in healthcare. Over the last few years, machine learning techniques (especially neural networks or deep neural networks) have been successfully applied to medical image classification. Classification modules may be used to provide an indication for the presence of a certain anatomy, pathology, object and/or organ in an image, but do not provide information with respect to a spatial location of the identified classification. Although some techniques for generating visual explanations associated with an output of a e.g. deep neural network classifier have been proposed, these methods provide means for measuring the impact of individual input voxels on the classifier decision. In some cases, however, these methods are limited in their practical applicability as resulting attribution heat maps may be diffuse and difficult to interpret.

### SUMMARY

The exemplary embodiments are directed to a computer-implemented method of training a machine learning module to provide classification and localization information for an image study, comprising: receiving a current image study; applying the machine learning module to the current image study to generate a classification result including a prediction for one or more class labels for the current image study using a classification module of the machine learning module; receiving, via a user interface, a user input indicating a spatial location corresponding to a predicted class label; and training a localization module of the machine learning module using the user input indicating the spatial location corresponding to the predicted class label.

The exemplary embodiments are directed to a system of training a machine learning module to provide classification and localization information for an image study, comprising: a non-transitory computer readable storage medium storing an executable program; and a processor executing the executable program to cause the processor to: receive a current image study; apply the machine learning module to the current image study to generate a classification result including a prediction for one or more class labels for the current image study using a classification module of the machine learning module; receive, via a user interface, a user input indicating a spatial location corresponding to a predicted class label; and train a localization module of the machine learning module using the user input indicating the spatial location corresponding to the predicted class label.

The exemplary embodiments are directed to a non-transitory computer-readable storage medium including a set of instructions executable by a processor, the set of instructions, when executed by the processor, causing the processor to perform operations, comprising: receiving a current image study; applying a machine learning module to the current image study to generate a classification result including a prediction for one or more class labels for the current image study using a classification module of the machine learning module; receiving, via a user interface, a user input indicating a spatial location corresponding to a predicted class label; and training a localization module of the machine learning module using the user input indicating the spatial location corresponding to the predicted class label.

### BRIEF DESCRIPTION OF THE DRAWINGS

FIG. 1 shows a schematic diagram of a system according to an exemplary embodiment.

FIG. 2 shows another schematic diagram of the system according to FIG. 1.

FIG. 3 shows a schematic user interface according to an exemplary embodiment.

FIG. 4 shows another schematic user interface according to an exemplary embodiment.

FIG. 5 shows a flow diagram of a method according to an exemplary embodiment.

### DETAILED DESCRIPTION

The exemplary embodiments may be further understood with reference to the following description and the appended drawings, wherein like elements are referred to with the same reference numerals. The exemplary embodiments relate to systems and methods for machine learning and, in particular, relate to systems and methods for dynamically extending and/or modifying a machine learning module. The machine learning module comprises a pre-trained classification module, which identifies a class label for a particular image study, and an untrained or partially trained localization module, which is to be trained using relevant spatial information provided by a user based on the identified class label and/or the image study. Thus, once the localization module has been trained to a stable state, the machine learning module may autonomously provide both a class label and a relevant spatial location for an image study. The classification module may also be configured to continually adapt based on other user input such as, for example, the addition of new classes and/or corrections to an identified class label. It will be understood by those of skill in the art that although the exemplary embodiments are shown and described with respect to X-ray images or image studies, the systems and methods of the present disclosure may be similarly applied to any of a variety of medical imaging modalities in any of a variety of medical fields for any of a variety of different pathologies and/or target areas of the body.

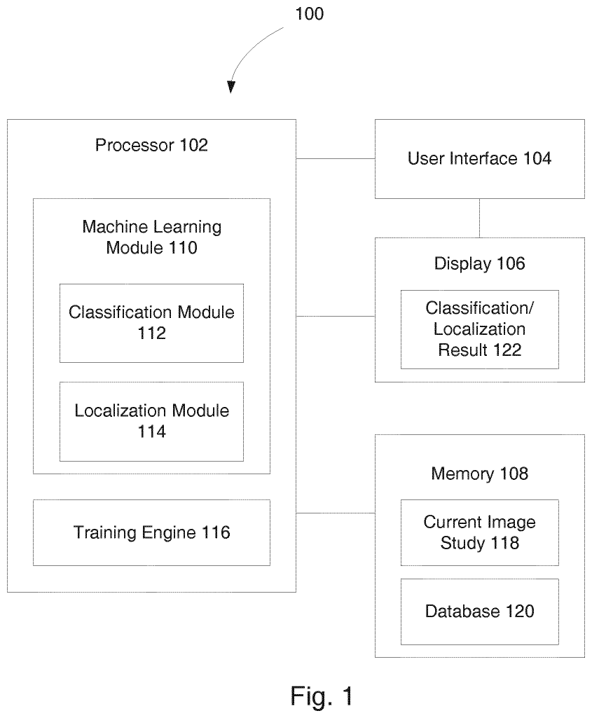

As shown in FIG. 1, a system 100, according to an exemplary embodiment of the present disclosure, applies a classification module to an image study to provide a classification decision for the image study to a user (e.g., clinician). The user may then input relevant information based on the image study and/or the classification decision. This relevant information, along with subsequent relevant information for subsequent image studies, may be used to train a localization module and/or continually adapt the classification module, as will be described below. The system 100 comprises a processor 102, a user interface 104, a display 106 and a memory 108. The processor 102 may comprise a machine learning module 110 and a training engine 116 for training the machine learning module 110. The machine learning module 110 is, for example, a deep learning network. There are various types of applicable deep learning networks as known in the art. However, other suitable or comparable types machine learning techniques may be used as would be understood by one having ordinary skill in the art. The machine learning module 110 may further include a classification module 112 and a localization module 114. The classification module 112 may be applied to a current image 118, which may be received and stored to the memory 108, to generate a classification and/or localization result 122 for the current image study 118 to the user via, for example, the display 106. Suitable techniques for the classification module 112 include, for example, deep learning techniques such as convolutional neural networks (e.g., densely connected neural networks, residual neural networks, networks resulting from architecture search algorithms, capsule networks etc.). Alternatively, techniques based on image descriptors (e.g. HOG, SURF, SIFT, Eigen-Features . . . ) and other machine learning techniques can be employed. The user may input, via the user interface 104, relevant information such as, for example, a bounding box showing a relevant spatial location of an identified classification (e.g., pathology, organ, object etc.), a new class for the classification module, and/or corrections to the classification decision for the current image study 118. This relevant information (e.g., user input) is added to a database 120 in the memory 108, which may be used by, for example, the training engine 116 for training one of the localization module 114 and/or classification module 112 of the machine learning module 110, as will be described in further detail below. Suitable techniques for the localization module include e.g. methods from the field of object detection/instance segmentation such as fast region-based convolutional neural networks, “you only look once” architectures, RetinaNets or Mask R-CNNs. Similarly, classification-based detectors (e.g. sliding windows methods), or voting-based techniques (e.g. Generalized Hough Transform, Hough Forest, etc.) can be employed.

In some embodiments, the classification module 112 of the machine learning module 110 has been pre-trained, during manufacturing, with training data including image studies (e.g., x-ray images or image studies) that have corresponding classification information so that the machine learning module 110 is delivered to a clinical site (e.g., hospital) with classification capabilities. Thus, the classification module 112 is trained to provide a medical image classification (e.g., class label) based on an image being analyzed. Image classifications provide, for example, an indication of a presence of a particular anatomy, pathology, object, organ, etc. Classes may include, for example, the presence of effusion, fractures, nodules, support devices, etc. Although the classification module 112 has been pre-trained, the classification module 112 may be configured to continually adapt by learning new user inputs such as, for example, new classes and/or classification corrections. In some embodiments, the classification module 112 may include an internal module such as, for example, an image classification module.

While the classification module 112 is pre-trained, the localization module 114 may be manufactured and delivered to the clinical site in an untrained state. Thus, with each use of the machine learning module 110, user input including spatial location information may be used to train the localization module 114 so that once the localization module is trained to a stable state, the localization module 114 will be capable of identifying a relevant spatial location of an identified class for a particular image study. In some embodiments, user inputs indicating relevant spatial information may include, for example, a bounding box drawn over a relevant portion of the image study. In some embodiments, the localization module 114 may include an internal module for bounding box detection. It will be understood by those of skill in the art that although the localization module 114 is described as being manufactured and delivered in an untrained state, the localization module 114 may also be delivered in a partially trained state using, for example, testing data acquired during a testing stage. With the acquisition of sufficient data and subsequent training, the machine learning module 110 may eventually be a fully trained, autonomous decision making system.

The user may input any relevant information via, the user interface 104, which may include any of a variety of input devices such as, for example, a mouse, a keyboard and/or a touch screen via the display 106. User inputs may be stored to the database 120 for training of the classification module 112 and/or localization module 114.

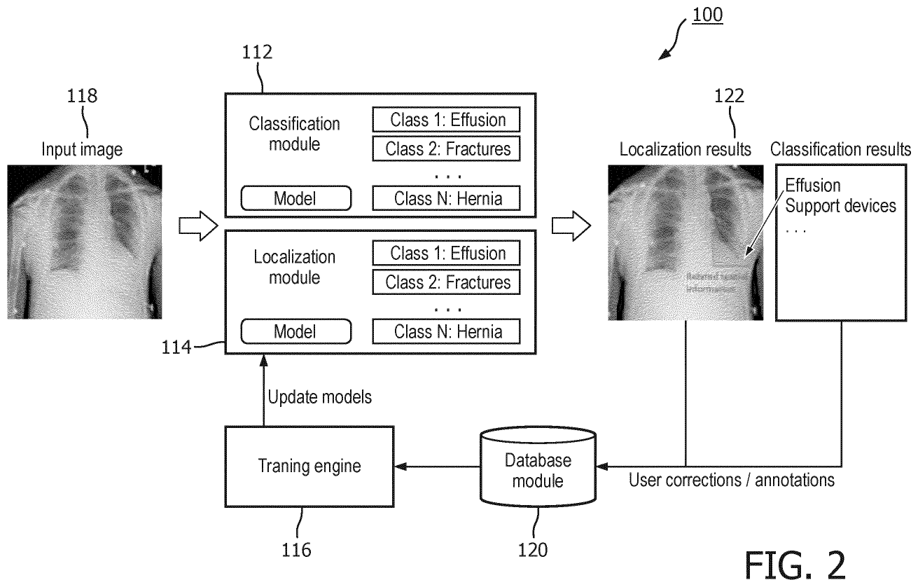

As shown in FIG. 2, the current image study 118, which requires an assessment/diagnosis, is directed to the machine learning module 110 so that the classification and localization results 122 based on the application of the classification module 112 and the localization module 114 are displayed. As described above, during earlier iterations of the machine learning module 110 in which the localization module 114 has not been trained to a stable state, the current image study 118 may be displayed to the user along with the classification result. Based on the displayed current image study 118 and/or the classification result for the current image study 118, the user may indicate a relevant spatial location by, for example, drawing a bounding box over a relevant portion of the displayed current image study 118.

The system 100 may keep track of labels for which the classification module 112 or localization module 114 is in a stable state. To determine whether a module is considered as stable for a certain label, the system 100 may rely on a set of predefined performance requirements and/or rules. An exemplary rule may be that at least 500 images containing the label were seen during on-site module adaptation. However, it should be understood that this is just one example of a predefined requirement/rule and other requirements and/or rules may also be used. Classification or localization results related to stable classes are forwarded to the user interface. Classification or localization results related to labels which are not considered to be stable may not be directly displayed to the user.

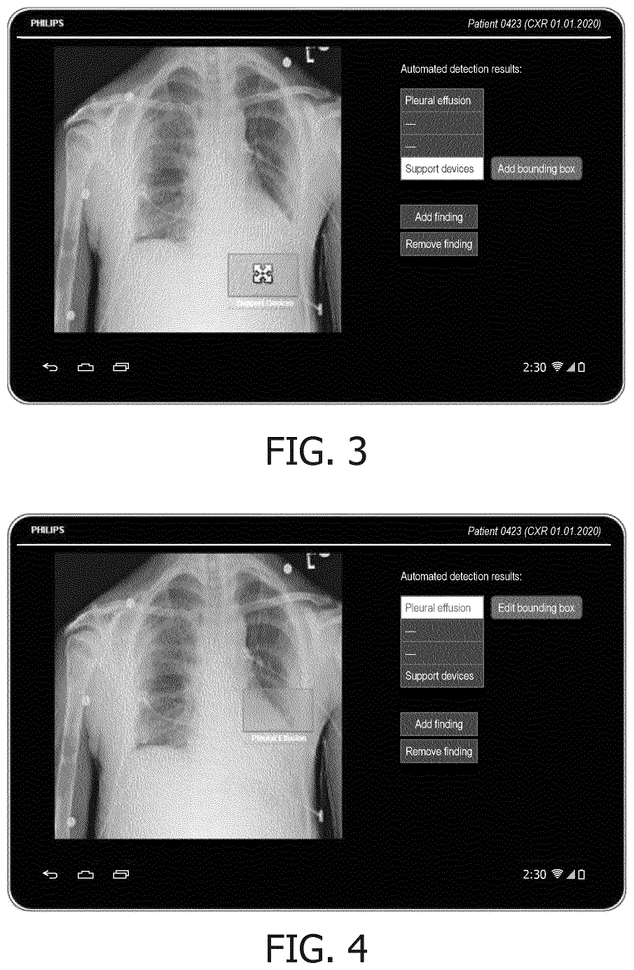

FIG. 3 shows an exemplary embodiment of a user interface displaying a classification and localization result for a current image study. In this example, the localization module 114 has not yet been trained to a stable state (e.g., trained to meet predetermined performance requirements) for at least one of the identified class labels. Where the localization module has not been trained to a steady state for a class label, the current image study is displayed to the user alongside the classification result so that the user may input relevant spatial location information such as, for example, a bounding box. The bounding box may be sized and positioned, as desired. Identified class labels may be selected by the user, as desired, to view any identified spatial locations (if stable) and/or input relevant spatial location for that class label (if unstable). Along with the automated classification results displayed to the user, the user interface may include options such as, for example adding a bounding box (or other relevant visual spatial location indication) to show a spatial location of a particular class indication, adding additional findings (e.g., additional class labels), and removing findings. It will be understood by those of skill in the art that the user interface may include other menu options related to the classification/localization result.

Where, however, the localization module 114 has been trained to a stable state for an identified class, the results 122 will show localization results along with the classification results. Localization results may include the spatial location via, for example, a bounding box over the relevant portion of the current image study 118. FIG. 4 shows an exemplary embodiment of a user interface displaying classification/localization results for an image study where the localization module 114 has been trained to a stable state for the identified class. As shown in FIG. 4, the localization is shown via a bounding box, which may be edited, if necessary. The user interface includes options such as, for example, editing a bounding box and adding findings. Bounding boxes may be edited, for example, by adjusting a location and/or size of the bounding box. Other additions, corrections and edits to the classification/localization results may also be performed by the user.

It will be understood by those of skill in the art that the user interfaces described and shown in FIGS. 3 and 4 are exemplary only. User interfaces may have any of a variety of configurations and include any of a variety of user options which may be displayed in any of a variety of ways so long as the classification/localization results are displayed to the user thereby. The user may edit either the localization result and/or the classification result, as desired.

Any user inputs such as, for example, relevant spatial location, edits, additions or corrections may be stored to the database 120 to be used by the training engine 116 to train the classification module 112 and/or localization module 114 accordingly.

Those skilled in the art will understand that the classification module 112 and the localization module 114 of the machine learning module 110 along with the training engine 116 may be implemented by the processor 102 as, for example, lines of code that are executed by the processor 102, as firmware executed by the processor 102, as a function of the processor 102 being an application specific integrated circuit (ASIC), etc. It will also be understood by those of skill in the art that although the system 100 is shown and described as comprising a computing system comprising a single processor 102, user interface 104, display 106 and memory 108, the system 100 may be comprised of a network of computing systems, each of which includes one or more of the components described above. In one example, the classification module 112 and the localization module 114 of the machine learning module 110 along with the training engine 116 may be executed via a central processor of a network, which is accessible via a number of different user stations. Alternatively, one or more of the classification module 112 and the localization module 114 of the machine learning module 110 along with the training engine 116 may be executed via one or more processors. Similarly, the database 120 may be stored to a central memory 108. The current image study 118 may be acquired from any of a plurality of imaging devices networked with or otherwise connected to the system 100 and stored to a central memory 108 or, alternatively, to one or more remote and/or network memories 108.

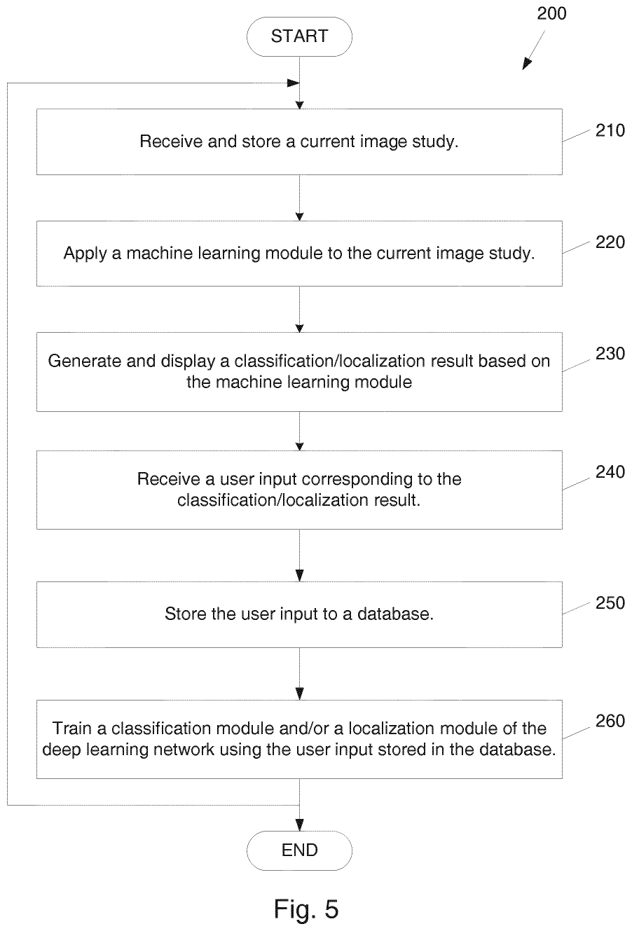

FIG. 5 shows an exemplary method 200 for providing classification/localization results for a current image study 118 and using user inputs to train a localization module 114 and/or a classification module 112 to expand and/or adapt a machine learning module 110 according to the system 100. In 210, the current image study 118 is received and/or stored to the memory 108 so that the machine learning module 110 may be applied to the current image study 118 in 220. Using the classification module 112 and the localization module 114, the machine learning module 110 provides a classification/localization result 122 to the user in 230. Classification results may include predictions of one or more findings including one or more class labels, which indicate a presence (or absence) of, for example, certain anatomies, pathologies, objects, or organs. Localization results may include a visual display of a spatial location of the predicted (e.g., identified as present) class labels. In 240, the user may provide user input, via the user interface 104, based on the classification/localization result 122.

As described above, however, for earlier iterations of the machine learning module 110, while the classification module 112 is pre-trained to be able to provide classifications (e.g., identify class labels) for the current image study 118, the localization module 114 may be untrained or partially trained so that the machine learning module 110 is not yet trained to show relevant spatial location information. Thus, in these cases, a user interface may show the current image study 118 along with the classification results so that the user input may include relevant spatial information via, for example, a bounding box drawn over a relevant portion of the current image study 118.

In later iterations, where the localization module 114 has been trained to a stable state, the classification/localization result 122 will identify relevant class labels and show relevant spatial locations for corresponding identified classes. In these embodiments, the user input may include editing of spatial information by, for example, adjusting a location and/or size of a displayed bounding box. Regardless of whether the localization module 114 is in a stable state, however, user inputs may also include other data such as, for example, adding findings (e.g., addition of class labels) and/or corrections to findings (e.g., removing findings or class labels).

In 250, all the user inputs are stored to the database 120 so that, in 260, the training engine 116 trains the machine learning module 110 to include the data from the database 120. In particular, the classification module 112 is trained with user inputs corresponding to classification results while the localization module is trained with user inputs corresponding to spatial location. The classification module 112 and the localization module 114, however, implement transfer-learning techniques (e.g., sharing of module components, sharing of feature maps) in order to exploit the commonalities of localization and classification tasks. For example, certain feature extractors or convolutional filters may be shared among both the classification module 112 and the localization module 114.

In some embodiments, the classification module 112 and the localization module 114 are deep neural networks and share the same layers as a backbone for an object detector. In other embodiments, only certain layers of the classification network and object detector backbone may be shared. In further embodiments, it is possible to implement the training setup in such a way that the classification and localization modules 112, 114 are updated in an alternating fashion. If the classification and localization modules 112, 114 share components, the training process may be configured in such a way that during the retraining of individual modules, certain layers/components (e.g., neural network convolutional filter weights) may be frozen. For example, during a gradient step with respect to the classification loss, a latter half of the layers of a shared deep neural network may be frozen while during a gradient step with respect to an object localization loss, a first half of the layers may be frozen. In other embodiments, it is also possible to implement the training setup in such a way that the classification and localization modules 112, 114 are jointly updated (e.g., by combining the classification and localization loss functionals and performing a joint backpropagation).

It will be understood by those of skill in the art that the method 200 may be continuously repeated so that machine learning module 110 is dynamically expanded and modified with each use thereof. In particular, since the localization module 114 is continuously trained with new localization data provided by the user, the localization module 114 will eventually be trained to a stable state so that the deep neural network 110 may provide a fully autonomous classification and localization result for an image study. Even when the deep neural network 110 is capable of providing a fully autonomous result, however, user input may be utilized to continually adapt and modify the deep neural network 110 to overcome shifts in data distribution (“domain bias”) and to mitigate the effect of catastrophic forgetting. An on-site adaption may be continued to be triggered based on a set of pre-defined rules (e.g., 1000 new images containing at least 10000 foreground/positive labels are available).

Those skilled in the art will understand that the above-described exemplary embodiments may be implemented in any number of manners, including, as a separate software module, as a combination of hardware and software, etc. For example, the machine learning module 110, classification module 112, localization module 114 and training engine 116 may be programs including lines of code that, when compiled, may be executed on the processor 102.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It will be apparent to those skilled in the art that various modifications may be made to the disclosed exemplary embodiments and methods and alternatives without departing from the spirit or scope of the disclosure. Thus, it is intended that the present disclosure cover the modifications and variations provided that they come within the scope of the appended claims and their equivalents.

What is claimed is:

1. A computer-implemented method of training a machine learning module to provide classification and localization information for an image study, comprising:
receiving a current image study;
applying the machine learning module to the current image study to generate a classification result including a prediction for one or more class labels for the current image study using a classification module of the machine learning module;
receiving, via a user interface, a user input indicating a spatial location corresponding to a predicted class label; and
training a localization module of the machine learning module using the user input indicating the spatial location corresponding to the predicted class label.

2. The method of claim 1, further comprising determining whether one of the classification module and the localization module for a class label meets predetermined performance requirements.

3. The method of claim 2, wherein, when the localization module for the class label meets predetermined performance requirements, applying the machine learning module to the current image study includes providing a visual representation of a spatial location of the class label when the classification result includes a prediction for the class label.

4. The method of claim 1, wherein the classification module identifies class labels indicating a presence of one of a particular anatomy, pathology, organ and object in the current image study.

5. The method of claim 1, wherein the user input indicates the spatial location corresponding to the predicted class label includes a bounding box drawn over a relevant portion of the current image study.

6. The method of claim 3, wherein the user input includes a user edit to one of the classification result and the visual representation of the spatial location of the class label.

7. The method of claim 6, further comprising training the classification module of the machine learning module using the user edit.

8. The method of claim 6, wherein the user edit includes one of an addition of a class label and a removal of the predicted class label from the classification result.

9. The method of claim 1, wherein training the localization module of the machine learning module includes transfer learning to share module components including one or more convolutional layers.

10. The method of claim 1, wherein the current image study is an X-ray image study.

11. A system of training a machine learning module to provide classification and localization information for an image study, comprising:
a non-transitory computer readable storage medium storing an executable program; and
a processor executing the executable program to cause the processor to:
receive a current image study;
apply the machine learning module to the current image study to generate a classification result including a prediction for one or more class labels for the current image study using a classification module of the machine learning module;
receive, via a user interface, a user input indicating a spatial location corresponding to a predicted class label; and
train a localization module of the machine learning module using the user input indicating the spatial location corresponding to the predicted class label.

12. The system of claim 11, wherein the processor executes the executable program to cause the processor to determine whether one of the classification module and the localization module for a class label meets predetermined performance requirements.

13. The system of claim 12, wherein, when the localization module for the class label meets the predetermined performance requirements, application of the machine learning module to the current image study includes providing a visual representation of a spatial location of class label, when the classification result includes a prediction for the class label.

14. The system of claim 11, wherein the classification module identifies class labels indicating a presence of one of a particular anatomy, pathology, organ and object in the current image study.

15. The system of claim 11, wherein the user input indicating the spatial location corresponding to the predicted class label includes a bounding box drawn over a relevant portion of the current image study.

16. The system of claim 13, wherein the user input includes a user edit to one of the classification result and the visual representation of the spatial location of the class label.

17. The system of claim 16, wherein the processor executes the executable program to cause the processor to train the classification module of the machine learning module using the user edit.

18. The system of claim 16, wherein the user edit includes one of an addition of a class label and a removal of the predicted class label from the classification result.

19. The system of claim 11, wherein training the localization module of the machine learning module includes transfer learning to share module components including one or more convolutional layers.

20. A non-transitory computer-readable storage medium including a set of instructions executable by a processor, the set of instructions, when executed by the processor, causing the processor to perform operations, comprising:
receiving a current image study;
applying a machine learning module to the current image study to generate a classification result including a prediction for one or more class labels for the current image study using a classification module of the machine learning module;
receiving, via a user interface, a user input indicating a spatial location corresponding to a predicted class label; and
training a localization module of the machine learning module using the user input indicating the spatial location corresponding to the predicted class label.
